(19) United States
(12) Patent Application Publication
(10) Pub. No.: US 2009/0079880 A1
(43) Pub. Date: Mar. 26, 2009

(54) Television Tuner

(75) Inventor: Koji Ohira, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Moriguchi-shi, Osaka (JP); SANYO TUNER INDUSTRIES CO., LTD., Daito-shi, Osaka (JP)

(21) Appl. No.: 11/909,913

(22) PCT Filed: Mar. 30, 2006
(86) PCT No.: PCT/JP2006/306723

§ 371 Date: Sep. 27, 2007

(30) Foreign Application Priority Data
Mar. 31, 2005 (JP) 2005-101666

(51) Int. Cl. H04N 5/50

(52) U.S. Cl. 348/731; 348/E05.097

(57) ABSTRACT

A correction circuit comprised of a capacitor and a switch is attached to a resonator such that a single resonance circuit is used to cover the television signals of a plurality of bands. Furthermore, the number of the components in the tuner circuit is reduced. A television tuner functions to receive a television broadcast signal divided into a plurality of frequency bands for conversion into an intermediate frequency signal of a predetermined frequency. The television tuner includes a resonance circuit controlling a frequency of a local oscillation signal which oscillates within a predetermined frequency band. During reception of a first frequency band, a tuning voltage is applied to a variable circuit element included in the resonance circuit to control the frequency of the local oscillation signal. During reception of a second frequency band, the tuning voltage is applied to the variable circuit element included in the resonance circuit and a correction control signal is applied to a non-variable circuit element connected to the variable circuit element to control the frequency of the local oscillation signal.

### TECHNICAL FIELD

The present invention relates to reduction in size and cost of a television tuner receiving a television signal.

### BACKGROUND ART

Digital television broadcasting has started in recent years. However, analog broadcasting will not be fully transitioned to digital broadcasting until the digital broadcasting infrastructure is completed.

By way of example, the current analog television signal has frequencies allocated to the UHF band (13-62 channels, per 6 MHz between 470 MHz and 770 MHz in Japan, per 6 MHz between 470 MHz and 890 MHz in the United States, and per 8 MHz between 470 MHz and 862 MHz in Europe), the VHF-Hi band (4-12 channels, per 6 MHz between 170 MHz and 222 MHz in Japan, per 6 MHz between 174 MHz and 216 MHz in the United States, and per 7 MHz between 174 MHz and 230 MHz in Europe), and the VEF-Lo band (1-3 channels, per 6 MHz between 90 MHz and 108 MHz in Japan, per 6 MHz between 54 MHz and 88 MHz in the United States, and per 7 MHz between 47 MHz and 68 MHz in Europe).

Conventionally, the circuit configuration shown in FIGS. 5 and 6 are generally used because reception of the above-mentioned analog broadcasting requires a wide frequency band. FIG. 5 is a schematic circuit block diagram of a conventional television tuner and FIG. 6 is a circuit diagram including a resonance circuit used in a television tuner product.

In FIG. 5, the television tuner includes a band separation circuit (23) connected to an antenna (41) receiving broadcast radio wave having a plurality of frequency bands, channel selection circuits (24), (25) of each band connected to band separation circuit (23), local oscillators (11), (17) oscillating at a predetermined frequency in accordance with each band, resonance circuits (2a), (2b) determining a frequency of the local oscillator to select a predetermined channel, a phase control circuit (12) phase-controlling resonance circuits (2a), (2b), mixers (26), (27) multiplying the signals from channel selection circuits (24), (25) by the signals from local oscillators (11), (17), respectively, an intermediate frequency signal (48) output from mixers (26), (27), a switching portion (18) selecting the band, and an intermediate frequency amplifier (9) amplifying intermediate frequency signal (48).

The television signal of the above-described wide band received from antenna (41) is, in band separation circuit (23) including a filter, divided into each band of the UHF band and the VHF band of analog television signals. Furthermore, local oscillators (11), (17) are provided which oscillate at different frequency bands depending on each band, and resonance circuits (2a), (2b) corresponding to their respective local oscillators (11), (17) are provided. The desired band is selected by phase control circuit (12) receiving a control signal (16) from a control circuit (15) to send the signal (marked with an asterisk (*)) as band and channel selection information required for the selection, to each circuit block.

Although the block diagram shows one resonance circuit (2b) of the VHF band, the VHF band is actually further divided into a high band (channels 4-12) resonance circuit and a low band (channels 1-3) resonance circuit in Japan. Furthermore, most of the circuits constituting the inside portion designated by the dashed line in the block diagram are large-scale integrated (U1) and each part corresponding to resonance circuits (2a), (2b) is externally connected to a terminal of the LSI. FIG. 6 shows a configuration of the LSI and the resonance circuit for the television tuner.

FIG. 6 shows a conventional example including three resonance circuits corresponding to their respective UHF, VHF-Hi and VHF-Lo frequency bands. One-chip LSI (for example, U1: a product available from Texas Instruments/the product name of TUNER-IC/the product number SN76164) is provided with VHF-Hi terminals (P30), (P31), VHF-Lo terminals (P32), (P1) and UHF terminals (P2), (P3), (P4), (P5) for inputting the resonance frequencies of the three bands, respectively.

Two VHF-Hi terminals (P30), (P31) are connected in series through a capacitor (C51), a resistor (R51) and a capacitor (C52). Resistor (51) has an end connected to a capacitor (C61), an inductor (51) and a variable capacitance diode (VC51) which are arranged in parallel to each other. Furthermore, variable capacitance diode (VC51) has a cathode connected to a capacitor (C62) and a resistor (R53) which are arranged in parallel to each other, and a tuning voltage (1) is applied to the cathode through an end of resistor (R53).

Two VHF-Lo terminals (P32), (P1) are also connected to each element in the manner almost similar to that of VHF-Hi terminals (P30), (P31). In other words, two VHF-Lo terminals (P32), (P1) are connected through capacitors (C53), (C54), respectively, and an inductor (L52), a variable capacitance diode (VC52) and a capacitor (C64) are connected in parallel between two capacitors (C53) and (C54). Furthermore, variable capacitance diode (VC52) has a cathode connected to a capacitor (C63) and a resistor (R54) which are arranged in parallel to each other, and tuning voltage (1) is applied to the cathode through an end of resistor (R54).

The UHF terminal is comprised of four terminals (P2), (P3), (P4), (P5). Two transistors (TR5), (TR6) incorporated in LSI (U1) have their respective bases and emitters corresponding to terminals (P2), (P3) and terminals (P5), (P4). Capacitors (C55), (C56), (C57) are connected between terminals (P2-P5) and three capacitors (C58), (C59), (C60) are further connected between two terminals (P2) and (P5). A variable capacitance diode (VC53) and a coil (L53) connected in series are connected in parallel to capacitor (C59). Coil (L53) has tuning voltage (1) applied through a resistor (R1). Furthermore, a capacitor (C65) is connected in parallel to variable capacitance diode (VC53) which has an anode grounded through a resistor (R52). The operation is then described.

In the case of the VHF-Hi band, capacitors (C61), (C62), coil (L51) and variable capacitance diode (VC51) mainly constitute an LC parallel resonance circuit. The control voltage value of tuning voltage (1) is changed so as to accommodate the desired channel frequency in the VHF-Hi band, to thereby cause the capacitance of variable capacitance diode (VC51) to be changed and the resonance frequency generated between two terminals (P30) and (P31) to be changed within the VHF-Hi band. Capacitors (C51), (C52) and resistor (R51) serve as a feedback capacitance of the LSI internal circuit. It is to be noted that resistor (R51) is used for preventing irregular oscillation.

The operation in the VHF-Lo band is also similar to that in the VHF-Hi band. Capacitors (C63), (C64), coil (L52) and variable capacitance diode (VC52) constitute an LC parallel resonance circuit. The control voltage value of tuning voltage (1) is changed so as to accommodate the desired channel frequency in the Vi-Lo band, to thereby cause the capacitance of variable capacitance diode (VC52) to be changed and the resonance frequency generated between two terminals (P32) and (P1) to be changed within the VHF-Lo band. Capacitors (C53), (C54) serve as a feedback capacitance of the LSI (U1) internal circuit.

The UHF band is similar to the VHF band in that the resonance frequency is changed in the LC parallel resonance circuit. Four terminals (P2, P3 and P5, P4) correspond to terminals of the base and emitter of each of the two transistors within LSI (U1) and generate resonance frequency between the collectors of the two transistors within LSI (U1). Terminals (P3), (P4), capacitors (C55-C60, C65), coil (L53) and variable capacitance diode (VC53) constitute an LC resonance circuit. A specified channel frequency within the UHF band is determined based on the control voltage value of tuning voltage (1) applied to variable capacitance diode (VC51). Transistors (TR5), (TR6) constituting local oscillator (11) is included within the IC.

The resonance circuit is configured of a closed loop circuit mainly including capacitor (C59), coil (L53) and variable capacitance diode (VC53). If coil (L53) is assumed to be non-variable, the resonance frequency can be changed by controlling variable capacitance diode (VC53) by tuning voltage (1). Two capacitors (C55), (C57) each correspond to a feedback capacitance between the base and the emitter of each of two transistors (TR5), (TR6), capacitor (C56) corresponds to a negative feedback capacitance between the emitters of two transistors (TR5), (TR6), capacitor (C58) corresponds to a coupling capacitance of the base of transistor (TR5), and capacitor (C60) corresponds to a coupling capacitance of the base of transistor (TR6).

In recent years, cost and size reduction is demanded in tuner technology and a significant technique for cost reduction is to reduce external discrete components. In a method disclosed by way of example, the local oscillation frequency used in a certain band is divided or multiplied to allow it to be used as a local oscillation frequency in another band (for example, refer to Patent Documents 1 and 2). In this method, division or multiplication of the resonance frequency in a band allows it to be used as a resonance frequency in another band in order to apply a resonance circuit used in one band to another band. However, this method poses the following problems.

### Patent Document 1: Japanese Patent Laying-Open No. 2000-32361

### Patent Document 2: Japanese Patent Laying-Open No. 2002-118795

The tuner basically functions to frequency-convert a selected channel frequency signal (RF) output from the channel selection circuit and a local oscillation frequency signal (Fosc) to a certain intermediate frequency signal (IF) in a mixer, as represented by an equation 1.

IF=Fosc−RF (Equation 1)

(If: intermediate frequency signal, Fosc: local oscillation frequency signal, RF: selected channel frequency signal)

It is to be noted that the intermediate frequency signal is 57 MHz in Japan.

If the resonance circuit is not shared, local oscillation signals (3a), (3b) are output from resonator circuits (2a), (2b) of each band. Although not shown, channel selection circuits (24), (25) includes a band-pass filter configured to achieve tuning to the selected channel frequency. The band-pass filter is configured in the same manner as the variable capacitance diode used in resonance circuits (2a), (2b) for local oscillators (11), (17), and the coil and the capacitor are selected as appropriate. This allows intermediate frequency (IF) to be output such that the difference between local oscillation frequency signal (Fosc) and selected channel frequency signal (RF) is kept constant (G in FIG. 10) relative to tuning voltage (1), as shown in FIG. 10.

In the case where the local oscillation signal in one band is used as a local oscillation signal in another band, however, there is a difference in frequency characteristic between the local oscillation frequency caused by the conventionally designed resonance circuit in accordance with each band and the divided local oscillation frequency. This requires correction to be made. FIGS. 8 and 9 show differences between the divided local frequency and the conventional local oscillation frequency. FIG. 8 shows tuning voltage-local oscillation frequency characteristics designated by a in the UHF band, designated by b in the VHF-Hi band and designated by c in the VHF-Lo band. FIG. 9 is an enlarged view of those in the VHF-Hi band and the VEF-Lo band. FIG. 8 shows solid lines b and c plotted by half-dividing and quarter-dividing the local oscillation signals, respectively, and also shows a dashed line and a dashed-dotted line each representing a characteristic diagram in which the resonance circuit is used in accordance with each conventional band.

In FIG. 9, there are deviations between the divided local oscillation frequency and the originally required local oscillation frequency in the areas corresponding to the lower control voltage (a portion A not more than about 8V) and the higher control voltage (a portion C not less than about 18V) in the VHF-Hi band, and in the area corresponding to the higher control voltage (a portion B not less than about 12V) in the VHF-Lo band. That is, IF≠Fosc−RF.

Thus, in the case where one resonance circuit is shared for local oscillation signals in the plurality of bands, the frequency characteristic of the resonance circuit for RF needs to be matched to the frequency characteristic of the local oscillation circuit. In other words, the control by the same tuning voltage (1) requires optimization so as to match the divided local oscillation frequency to the frequency characteristic of selected channel in each band.

Japanese Patent Laying-Open No. 2000-32361 discloses the application of the control voltage by a D/A converter as a method of correcting the frequency deviation (Japanese Patent Laying-Open No. 2000-32361, paragraphs [0052] to [0054]). This method, however, requires an additional D/A converter, which results in an increase in cost by using the D/A converter, rather than a decrease in cost by sharing the local oscillator in each band. Therefore, the method does not propose a practical solution.

### DISCLOSURE OF THE INVENTION

### Problems to be Solved by the Invention

According to the present invention, in order to cover the television signals of a plurality of bands by using one resonance circuit, a correction circuit comprised of a capacitor and a switch is added to a resonator to thereby constitute a resonance circuit so as to accommodate each band, the tuning voltages of the channel selection circuit and the resonance circuit of the local oscillator are shared, and the number of the components in the tuner circuit is reduced.

### Means for Solving the Problems

A television tuner of the present invention functions to receive a television broadcast signal divided into a plurality of frequency bands for conversion into an intermediate frequency signal of a predetermined frequency. The television tuner includes a resonance circuit (2) controlling a frequency of a local oscillation signal (8) which oscillates within a predetermined frequency band. During reception of a first frequency band, a tuning voltage (1) is applied to a variable circuit element (VC1) included in resonance circuit (2) to control the frequency of local oscillation signal (8). During reception of a second frequency band, tuning voltage (1) is applied to variable circuit element (VC1) included in resonance circuit (2) and a correction control signal is applied to a non-variable circuit element connected to the variable circuit element, to control the frequency of local oscillation signal (8).

Furthermore, resonance circuit (2) includes a coil (L1) and a capacitor (C3) connected in series, a variable capacitance diode (VC1) is connected in parallel to coil (L1) and capacitor (C3) which are connected in series, tuning voltage (1) is applied to one end of variable capacitance diode (VC1) through a resistor (R1), correction capacitors (C1), (C2) are connected in parallel to a connection point between variable capacitance diode (VC1) and resistor (R1), correction capacitors (C1), (C2) each have an end grounded through a switch (TR1), (TR2), switch (TR1), (TR2) is turned on and turned off by applying a first correction control signal (6), (7), variable capacitance diode (VC1) has the other end grounded through a resistor (13), a voltage dividing resistor (R4), (R5) is connected to a connection point between variable capacitance diode (VC1) and resistor (R3), and a second correction control signal (4), (5) is applied to an end of voltage dividing resistor (R4), (R5).

Resonance circuit (2) includes a coil (L1) and a capacitor (C3) connected in series, a variable capacitance diode (VC1) is connected in parallel to coil (L1) and capacitor (C3) which are connected in series, tuning voltage (1) is applied to one end of variable capacitance diode (VC1) through a resistor (R1), correction resistors (R12), (R13) are connected in parallel to a connection point between variable capacitance diode (VC1) and resistor (R1), the correction resistors each have an end grounded through a switch (TR3), (TR4), switch (TR3), (TR4) is turned on and turned off by applying a first correction signal (6), (7), variable capacitance diode (VC1) has the other end grounded through a resistor (13), a voltage dividing resistor (R4), (R5) is connected to a connection point between variable capacitance diode (VC1) and resistor (R3), and a second correction control signal (4), (5) is applied to an end of voltage dividing resistor (R4), (R5).

The television tuner further includes a divider (10) dividing local oscillation signal (8), a channel selection circuit (24), (25) selecting a selected channel frequency, a mixer (26), (27) multiplying local oscillation signal (8) or a divided local oscillation signal (33) by a selected channel frequency signal (46), (47) output from channel selection circuit (24), (25), and an intermediate frequency amplifier (9) amplifying an intermediate frequency signal (48) from mixer (26), (27). Local oscillation signal (8) is output to mixer (26) during reception of the first frequency band, and divided local oscillation signal (33) is output to mixer (27) during reception of the second frequency band, to share resonance circuit (2) for local oscillation signal (8) in a plurality of frequency bands.

### EFFECTS OF THE INVENTION

According to the present invention, a television tuner capable of receiving television signals in a plurality of bands is configured such that a capacitor, a resistor and a switch are added to a resonator to thereby cover all bands using one resonator. This allows elimination of the components of the external resonance circuit other than those in the first frequency band of the tuner circuit and also allows the number of the components for local oscillation in the resonance circuit to be reduced about by half. The transistor corresponding to a switch can be incorporated into the LSI, which allows the number of the components to be further reduced.

### BEST MODES FOR CARRYING OUT THE INVENTION

### First Embodiment

FIG. 1 shows an embodiment of the present invention and illustrates the configuration and the operation thereof.

A television tuner of the present invention includes a resonance circuit (2) controlling a local oscillation signal (8) in order to select the desired channel. In resonance circuit (2), a coil (L1), a capacitor (C3) and a variable capacitance diode (VC1) constitute an LC resonance circuit to which a tuning voltage (1) is applied through a resistor (R1). Furthermore, depending on the frequency band, second correction control signals (4), (5) and first correction control signals (6), (7) are input to circuit elements (R4, R5), (C1, TR1, C2, TR2) connected to LC resonance circuit (L1, VC1, C3). Second correction control signals (4), (5) are applied such that the reverse electric potential of variable capacitance diode (VC1) decreases. First correction control signals (6), (7) cause capacitors (C1), (C2) connected in parallel to resonance circuit (2) to be operated to change the capacitance of resonance circuit (2).

In addition, tuning voltage (1) is also used for controlling the resonance circuit within channel selection circuits (24), (25).

In the case of the normal UHF reception, the conventional method controlling the oscillation frequency of LC resonance circuit (L1, VC1, C3) by tuning voltage (1) allows the frequency control as in “a” in FIG. 8. In the case of the VHF-Hi reception, the local oscillation signal is divided, which is represented by a solid line b in FIG. 8. In this case, matching to the frequency of the channel selection circuit portion is required as described in detail in the conventional example, and thus, the solid line in a portion A (not more than about 8V) shown in FIG. 9 in which the control voltage is low should be lowered to the dashed line. In this method, voltage dividing resistors (R3), (R5) are used to perform correction such that, for example, 4.5V of second correction control voltage (4) is applied to achieve 0.5V of anode potential of variable capacitance diode (VC1). Consequently, the potential difference within variable capacitance diode (VC1) is relatively reduced, to thereby increase the capacitance of variable capacitance diode (VC1) as shown in D in FIG. 7. A frequency F is expressed by F=1/(2π(LC)^{1/2}) and thus the frequency is lowered, which causes the frequency characteristic to be lowered to the dashed line as shown in portion A in FIG. 9. As shown in E in FIG. 7, the capacitance of variable capacitance diode (VC1) is only slightly changed in the area corresponding to higher voltage (B in FIG. 9). Thus, no effect can be expected from the method by applying the above-described second correction control signal. Therefore, first correction control signal (6) is used to set a switch (TR1) to its on-state and increase the capacitance of the LC resonance circuit, to thereby allow the frequency to be lowered to the dashed line in B shown in FIG. 9.

The VHF-Lo reception is similar in operation to the VHF-Hi reception. Although not required in the experiment of the present LSI, if the correction is required in the low frequency band, second correction control voltage (5) only needs to be applied. In the area corresponding to the high tuning control voltage (E in FIG. 7), first correction control signal is applied to set a switch (TR2) to its on-state and increase the capacitance of the LC resonance circuit, to thereby allow the resonance frequency to be lowered.

### Second Embodiment

FIG. 2 shows another embodiment. In the present embodiment, a first correction resistor (R12) and a second correction resistor (R13) are used in place of a first correction capacitor (C1) and a second correction capacitor (C2) in FIG. 1. The operation in the correction is the same as in the embodiment in FIG. 1. However, an appropriate resistance ratio is provided to allow the tuning voltage to be divided during the operation of switches (TR3), (TR4). Consequently, the tuning voltage applied to resonance circuit (2) can be substantially lowered relative to the tuning voltage applied to channel selection circuits (24), (25), and the resonance frequency can be lowered.

### Third Embodiment

Furthermore, FIGS. 3 and 4 show illustrative embodiments. FIG. 3 is a block diagram of the present invention and FIG. 4 shows an embodiment of an implementation circuit using a tuner LSI. FIG. 3 shows a schematic structure of the tuner issuing an intermediate frequency signal (48) from an antenna (41) receiving the broadcast radio wave, and a resonance circuit constituting a UHF local oscillator, which are similar to those in the conventional example in FIG. 5. Therefore, the description thereof will not be repeated.

FIG. 3 is different from the conventional example (FIG. 5) in that, in the case of receiving the band other than the first frequency band, local oscillation signal (8) output from a local oscillator (17) is frequency-divided to accommodate the predetermined frequency in accordance with each band. For example, local oscillation signal (8) for the UHF band is divided by a divider (10) (for example, by one-half, by one-fourth) for application as a local oscillation signal (33) for the VHF-Hi band and the VHF-Lo band.

As described in detail in the first and second embodiments, resonance circuit (2) is provided with correction control means for accommodating a receiving band other than the first frequency band, to change the capacitance of the resonance circuit or to adjust the reverse voltage applied to variable capacitance diode (VC1). Selections with regard to local oscillation signal (33) and the correction control means are determined based on the signal (marked with an asterisk (*)) with which a phase control circuit (12) receives a signal (16) from a control circuit (15) for performing channel selection to select each circuit.

FIG. 4 shows an embodiment of a product circuit of the present invention, in which resonance circuit (2) is connected to an LSI (U1).

Resonance circuit (2) has a configuration comprised of a capacitor (C59), a coil (L53) and a variable capacitance diode (VC53) and similar to that in the first embodiment (FIG. 1). First correction control signals (6), (7) and second correction control signals (4), (5) are acted at a DC voltage not more than 3V. This allows transistors (TR1), (TR2) corresponding to the correction control means to be incorporated into the LSI.

In the case of receiving the band (for example, the VHF band) other than the first frequency band, when resonance frequency (8) is divided, the divided local oscillation frequency (the solid line portion) needs to be lowered to the practically required resonance frequency (the dashed line portion and the dashed-dotted line portion) in the areas corresponding to the low tuning voltage (portion A) in the VHF-Hi band, the high tuning voltage (portion B) in the VHF-Hi band and the high tuning voltage (portion C) in the VHF-Lo band, as shown in FIG. 9. Thus, it becomes necessary to increase the capacitance value of the capacitor of the resonator or to lower the tuning voltage applied to the LC resonator (L53, C59, VC53) relative to the tuning voltage applied to the channel selection circuit. FIG. 7 shows a characteristic diagram of the tuning voltage and the capacitance value of the variable capacitance diode in which the capacitance value shows an abrupt change in the area of lower voltage, but little change in the area of higher voltage. Therefore, the correction in the area corresponding to the low tuning voltage (not more than about 8V) in the VHF-Hi band requires the second correction control signal to be applied as an offset potential to the anode side of the diode and the reverse electric potential applied to the variable capacitance diode to be substantially lowered to increase the capacitance value.

Furthermore, the change of the second correction control signal does not cause a significant change in the capacitance in each area corresponding to higher voltages in the VHF-Hi band and the VHF-Lo band. Thus, if switches (TR1), (TR2) turned on and turned off by the first correction control signal are incorporated into the LSI, the capacitance of each of capacitors (C66), (C77) becomes a load of the resonance circuit during the on-state, to allow the resonance frequency to be lowered. During the UHF reception, the resonance circuit including variable capacitance diode (VC53), coil (L53) and capacitor (C59) can perform frequency-control by means of tuning voltage (1) as conventionally, and the correction control means does not need to be operated.

According to the present invention, only the correction means is provided in a part of the resonance circuit without newly adding an expensive component, and the tuning voltage itself set in phase control circuit (12) is shared between the local oscillation circuit and the channel selection circuit. Consequently, the tuner can be manufactured at low cost. Furthermore, since the resonance circuit for the local oscillation circuit is shared among all the bands, the number of the components in the resonance circuit for the local oscillator required for each band can be significantly reduced. Fifteen components such as a coil, a resistor, a diode and the like are included in the conventional example (FIG. 6), whereas only five components such as a coil and a resistor are included in the present invention (FIG. 4), which results in an advantage of reducing the components more than by half.

### BRIEF DESCRIPTION OF THE DRAWINGS

FIG. 1 shows an embodiment of the present invention.

FIG. 2 shows another embodiment of the present invention.

FIG. 3 shows an embodiment of the present invention.

FIG. 4 shows an embodiment of the present invention.

FIG. 5 shows a conventional example.

FIG. 6 shows a conventional example.

FIG. 7 shows a voltage-capacitance characteristic diagram of a variable capacitance diode.

FIG. 8 shows characteristics of a tuning voltage to a frequency output from a local oscillator and a divided frequency.

FIG. 9 is a partially enlarged view of FIG. 8.

FIG. 10 shows a difference between a local oscillation frequency representing an intermediate frequency and a selected channel frequency.

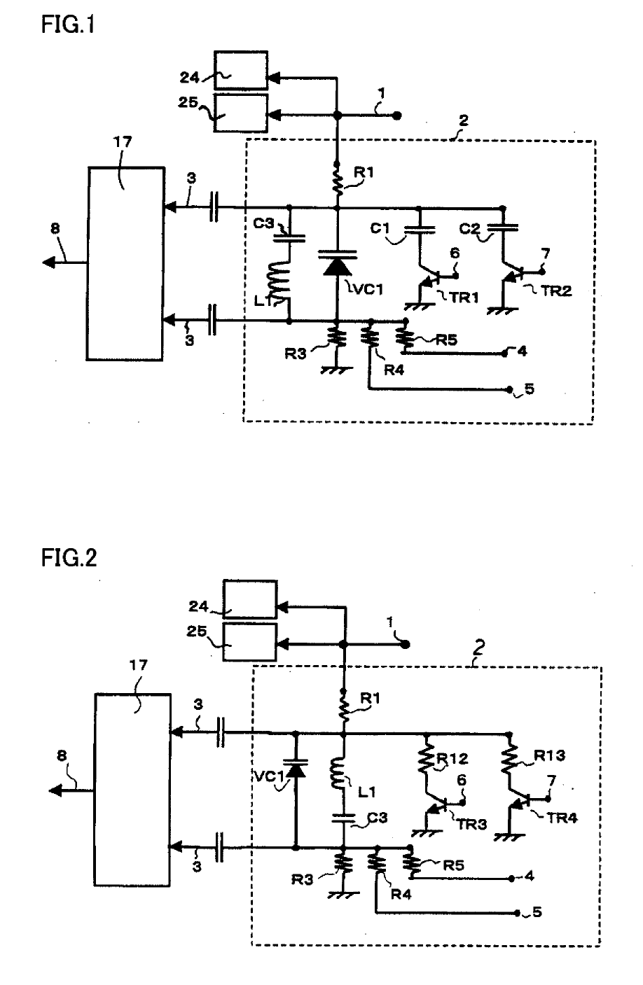

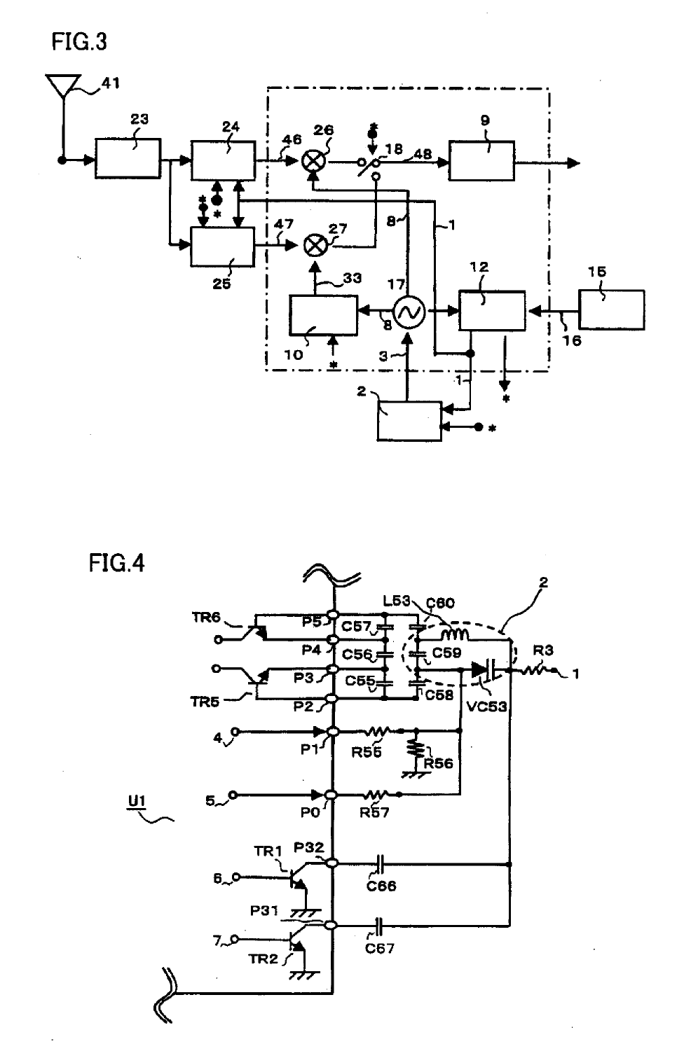

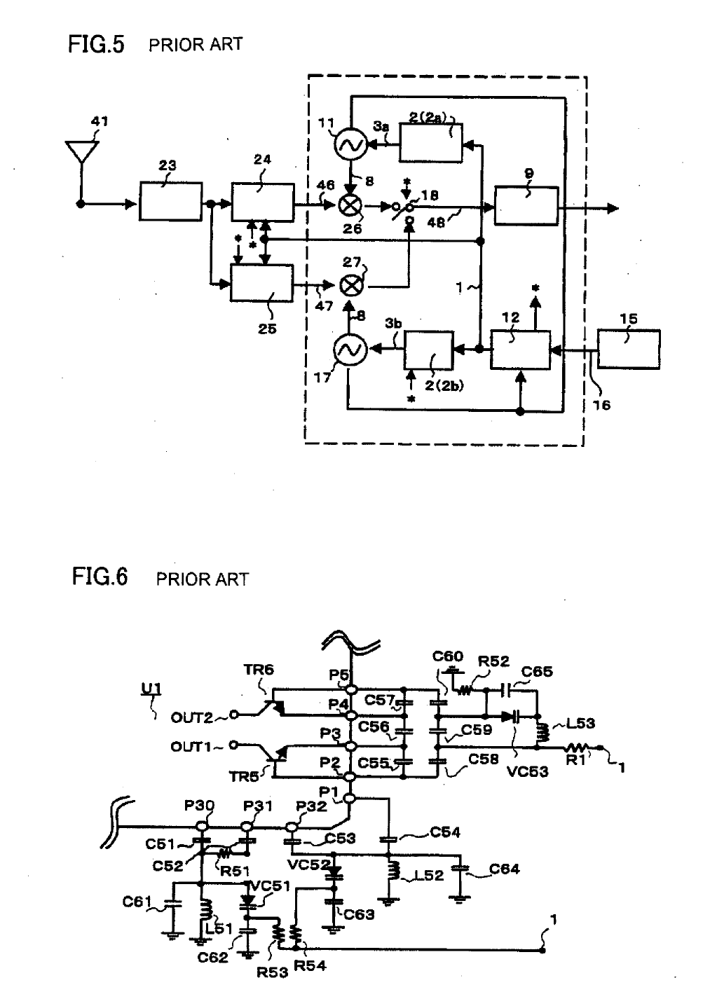

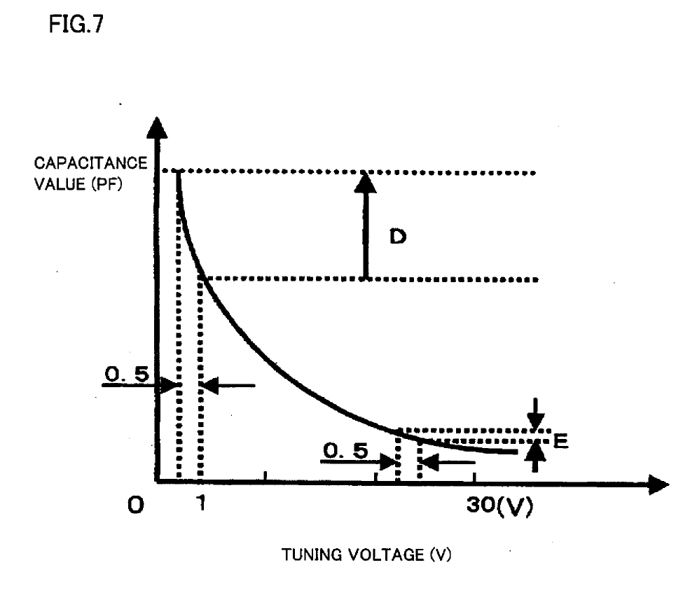

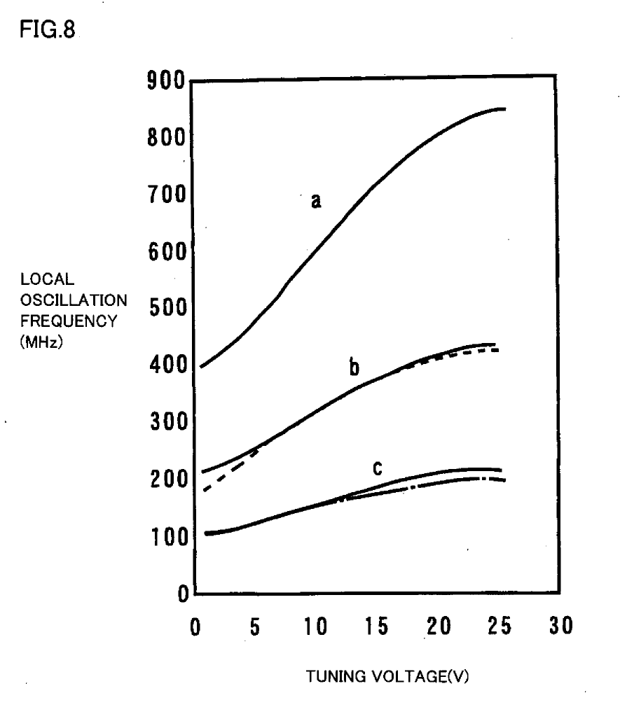

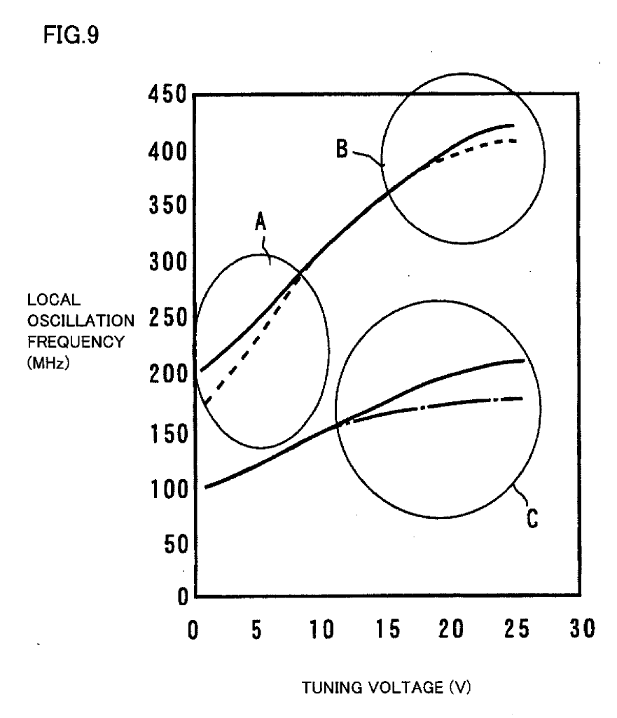

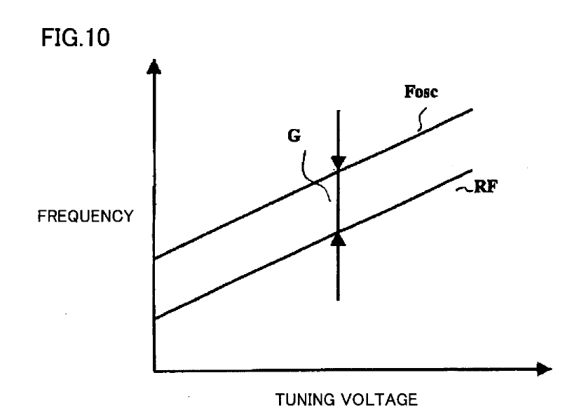

### DESCRIPTION OF THE REFERENCE SIGNS

1 tuning voltage, 2 resonance circuit, 3 resonance signal, 4, 5 first correction control signal, 6, 7 second correction control signal, 8 local oscillation signal, 9 intermediate frequency amplifier, 10 divider, 12 phase control circuit, 15 control circuit, 16 control signal, 11, 17 local oscillator, 18 switch, 23 band separation circuit, 24 (UHF) channel selection circuit, 25 (VHF) channel selection circuit, 26, 27 mixer, 33 divided local oscillation signal, 46, 47 selected channel frequency signal, 48 intermediate frequency signal.

1. A television tuner receiving a television broadcast signal divided into a plurality of frequency bands for conversion into an intermediate frequency signal of a predetermined frequency, the television tuner comprising a resonance circuit controlling a frequency of a local oscillation signal which oscillates within a predetermined frequency band, wherein
during reception of a first frequency band, a tuning voltage is applied to a variable circuit element included in the resonance circuit to control the frequency of the local oscillation signal, and during reception of a second frequency band, the tuning voltage is applied to the variable circuit element included in said resonance circuit and a correction control signal is applied to a non-variable circuit element connected to the variable circuit element, to control the frequency of the local oscillation signal.

2. The television tuner according to claim 1, wherein
the variable circuit element is a variable capacitance diode, the resonance circuit includes a coil and a capacitor connected in series, the variable capacitance diode is connected in parallel to the coil and the capacitor which are connected in series, the tuning voltage is applied to one end of the variable capacitance diode through a resistor, correction capacitors are connected in parallel to a connection point between the variable capacitance diode and the resistor, the correction capacitors, each have an end grounded through a switch, the switch is turned on and turned off by applying a first correction control signal, the variable capacitance diode has the other end grounded through a resistor, a voltage dividing resistor is connected to a connection point between the variable capacitance diode and the resistor, and a second correction control signal is applied to an end of the voltage dividing resistor.

3. The television tuner according to claim 1, wherein
the variable circuit element is a variable capacitance diode, the resonance circuit includes a coil and a capacitor connected in series, the variable capacitance diode is connected in parallel to the coil and the capacitor which are connected in series, the tuning voltage is applied to one end of the variable capacitance diode through a resistor, correction resistors are connected in parallel to a connection point between the variable capacitance diode and the resistor, the correction resistors each have an end grounded through a switch, the switch is turned on and turned off by applying a first correction signal, the variable capacitance diode has the other end grounded through a resistor, a voltage dividing resistor is connected to a connection point between the variable capacitance diode and the resistor, and a second correction control signal is applied to an end of the voltage dividing resistor.

4. The television tuner according to any of claims 1-3, comprising
a divider dividing the local oscillation signal, a channel selection circuit selecting a selected channel frequency, a mixer multiplying the local oscillation signal or a divided local oscillation signal by a selected channel frequency signal output from the channel selection circuit, and an intermediate frequency amplifier amplifying an intermediate frequency signal from the mixer, wherein
the local oscillation signal is output to the mixer during reception of the first frequency band, and the divided local oscillation signal is output to the mixer during reception of the second frequency band, to share the resonance circuit for the local oscillation signal in a plurality of frequency bands.
